(19) United States
(12) Patent Application Publication
(10) Pub. No.: US 2011/0177266 A1
(43) Pub. Date: Jul. 21, 2011

(54) FIRING AID

(75) Inventor: Stephan Miller, Traunstein (DE)

(73) Assignee: Dekema Dental-Keramikofen GmbH, Freilassing (DE)

(21) Appl. No.: 12/943,638

(22) Filed: Nov. 10, 2010

(30) Foreign Application Priority Data
Nov. 11, 2009 (DE) 102009052686.2

(51) Int. Cl. B32B 1/08; C04B 35/64; B23Q 3/00

(52) U.S. Cl. 428/34.4; 264/681; 264/605; 269/289 R

(57) ABSTRACT

A firing aid, in particular for supporting material to be fired in a furnace during filing, is obtainable by a method including the following steps:
a) providing a mixture of
   at least 60% by weight mullite powder which comprises 74.0 to 78.0% by weight Al₂O₃, 22.0 to 26% by weight SiO₂ and a maximum of 0.5% contaminants, with the sum of the Al₂O₃ content and of the SiO₂ content amounting to at least 99.5% by weight;
   1 to 20% by weight binder;
   0 to 20% by weight plasticizer; and
   remainder to 100% by weight of one or more additives;
b) pressing the mixture provided in step a) to a green body; and
c) sintering the green body.

The present invention relates to a firing aid, to a method for its manufacture, to its use and to a firing aid green body.

Moldings are termed firing aids in which the material to be fired, that is the component(s) to be fired, are supported or carried during a heat treatment carried out, for example, in a furnace. Consequently, the firing aids are in direct contact with the material to be fired during the thermal treatment. As a result, firing aids have to have great temperature stability, in particular high resistance to temperature change, great shape retention and a thermal coefficient of expansion which is as minimal as possible. In addition, no components may release from the firing aid during the heat treatment to avoid any contamination or even discoloration of the material to be fired, of the furnace atmosphere and/or of the furnace.

To satisfy these demands, as a rule, firing aids of silicon carbide are currently used, because silicon carbide is characterized by comparatively high temperature resistance and resistance to temperature change. However, such a firing aid on the basis of silicon carbide can result in pollution at the material, in particular with a longer operating time and in particular at comparatively high heat treatment temperatures of, for example, higher than 1600° C. or even higher than 1800° C. The durability of such firing aids on the basis of silicon carbide is furthermore in need of improvement.

It is therefore the object of the present invention to provide a firing aid which not only has high temperature stability, high resistance to temperature change, great shape retention and a small thermal coefficient of expansion, but which also does not result in a contamination or discoloration of the material to be fired, of the furnace atmosphere and/or of the furnace during its use and is also characterized by long durability.

This object is satisfied in accordance with the invention by a firing aid, in particular for supporting material to be fired during the firing in a furnace, which can be obtained by a method including the following steps:

a) providing a mixture of
at least 60% by weight mullite powder which comprises 74.0 to 78.0% by weight Al₂O₃, 22.0 to 26% by weight SiO₂ and a maximum of 0.5% contaminants, with the sum of the Al₂O₃ content and of the SiO₂ content amounting to at least 99.5% by weight;
1 to 20% by weight binder;
0 to 20% by weight plasticizer; and
remainder to 100% by weight of one or more additives;
   b) pressing the mixture provided in step a) to a green body; and
   c) sintering the green body.

It was able to be found within the framework of the present invention that a firing aid which can be obtained as above is characterized by high temperature stability, by high resistance to temperature change, by great shape retention, by a small thermal coefficient of expansion as well as by a long durability and no components are released from this firing aid, even after a long operating duration, in particular also at high firing temperatures, so that contamination and discoloration both of the material to be fired and of the furnace atmosphere and of the furnace are reliably prevented. The latter is in particular due to the high purity of the mullite used which only comprises unavoidable contaminants, but in particular no silicon carbide, no zirconium oxide and no titanium dioxide. In addition, the firing aid provides a uniform baking. As a result of this, the firing aid in accordance with the invention is in particular also exceptionally suitable for use in heat treatments which are carried out at a temperature of higher than 1600° C. such as for firing dental medical ceramic articles such as crowns.

Mullite is a material from the general class of aluminate silicates which has an orthorhombic crystal structure and approximately corresponds to the general formula Al₈[(O, OH, F)|(Si, Al)O₄]₄. Independently of whether it is mullite of natural origin or a synthetic mullite, this material has moderate or abundant contaminants and varies greatly with respect to the aluminum oxide content and silicium dioxide content. In the firing aid in accordance with the invention, a mullite is specifically used which has a specific aluminum oxide content of 74.0 to 78.0% by weight Al₂O₃ and a specific silicium dioxide content of 22.0 to 26% by weight SiO₂, with the total content of aluminum oxide and silicium dioxide amounting to at least 99.5% by weight and which comprises a maximum of 0.5% by weight contaminants. The contaminants can be alkali oxides or alkaline-earth oxides such as calcium oxide, magnesium oxide, potassium oxide and sodium oxide. The mullite used in accordance with the invention preferably does not comprise any other contaminants than alkali oxides and/or alkaline-earth oxides and particularly preferably no other contaminants than calcium oxide, magnesium oxide, potassium oxide and/or sodium oxide. The mullite used in accordance with the invention in particular preferably does not comprise any silicon carbide, any zirconium dioxide or also any titanium dioxide.

Particularly good results are in particular obtained when the mullite including in the firing aid or the mullites used in step a) comprises 75.0 to 77.0% by weight Al₂O₃, 23.0 to 25% by weight SiO₂ and a maximum of 0.5% by weight contaminants, with the sum of the Al₂O₃ content and of the SiO₂ content amounting to at least 99.5% by weight.

The quantity of contaminants in the mullite preferably amounts to a maximum of 0.3% by weight, particularly preferably a maximum of 0.2%, very particularly preferably a maximum of 0.1% by weight, and most preferably less than 0.01% by weight.

In accordance with a particularly preferred embodiment of the present invention, the firing aid comprises mullite or mullite is used in step a) which comprises 75.75 to 76.25% by weight Al₂O₃, 23.25 to 23.75% by weight SiO₂ and remainder exclusively calcium oxide, magnesium oxide, potassium oxide and sodium oxide as contaminants. A suitable example for this is a mullite comprising 76.0% by weight Al₂O₃, 23.5% by weight SiO₂ and remainder calcium oxide, magnesium oxide, potassium oxide and sodium oxide as contaminants.

The mullite content of the firing aid in accordance with the invention should generally be as high as possible because it is responsible for the high temperature stability, high resistance to temperature change and great shape retention of the firing aid. However, the firing aid can comprise specific quantities of binder and/or plasticizer which are added in the manufacture of the firing aid so that the mullite material can be processed by pressing and subsequent sintering into the shape of a firing aid and which are not completely vaporized out of the material in the subsequent sintering step. Good results are in particular obtained when the firing aid comprises at least 70% by weight, preferably at least 80% by weight, and particularly preferably at least 90% by weight mullite and most preferably consists of mullite.

A suitable quantity of a suitable binder must be added to the mullite powder in the manufacture of the firing aid to achieve a good processing capability of the mullite material used to form the firing aid. Good results are in particular achieved in this respect with organic binders, with the quantity of the organic binder amounting to, with respect to the firing aid, preferably 1 to 20% by weight, particularly preferably 2 to 15% by weight, in particular preferably 3 to 12% by weight and most preferably 3 to 6% by weight.

It is proposed in a further development of the invention that the firing aid is selected from the group comprising polyvinyl acetate, partially saponified polyvinyl acetate, polyvinyl alcohol and any desired mixtures of two or more of the aforesaid compounds. However, binders can furthermore also be used on the basis of acryl.

Particularly good results are in particular obtained when partially saponified polyvinyl acetate is used as the binder, with the degree of saponification of the polyvinyl acetate amounting to 50 to 95 atomic percent, preferably 70 to 90 atomic percent and particularly preferably 75 to 90 atomic percent.

To increase the manufacturability, a plasticizer is preferably added to the mullite powder on the manufacture of the firing aid in accordance with the invention with its quantity preferably amounting to 0.1 to 20% by weight, particularly preferably 0.5 to 15% by weight, in particular preferably 0.5 to 10% by weight, further preferably 0.5 to 5% by weight, and most preferably 1 to 5% by weight.

In accordance with a particularly preferred embodiment of the present invention, the plasticizer is polyethylene glycol, glycerin, water, a mixture of polyethylene glycol and water or a mixture of glycerin and water, with a mixture of glycerin and water being particularly preferable.

It was found within the framework of the present invention that the temperature stability also depends on the grain size of the mullite comprised in the firing aid. It is therefore proposed in a further development of the idea of the invention that the firing aid comprises mullite having a mean grain size of a maximum of 100 μm, particularly preferably of a maximum of 75 μm, and very particularly preferably of 10 to less than 75 μm.

It has furthermore proved to be advantageous if the firing aid comprises two or more mullites each having different particle sizes or two if or more mullites are used in step a) each having different particle sizes. Particularly good results are achieved in this embodiment when the firing aid comprises a mixture of two mullites, with the one mullite having an average particle size between 46 and 74 μm and the other mullite having an average particle size between 10 and 45 μm. Both mullites can generally have the same chemical composition or can have a chemical composition different from one another as long as both mullites each comprise 74.0 to 78.0% by weight Al₂O₃, 22.0 to 26% by weight SiO₂ and a maximum of 0.5% by weight contaminants, with the sum of the Al₂O₃ content and of the SiO₂ content amounting to at least 99.5% by weight. Both mullites preferably each have the same chemical composition in this embodiment.

The firing aid in accordance with the invention can generally have any desired form suitable for use as a firing aid. The firing aid can, for example, have the form of a circular hollow cylinder or of a ring which is closed by a base at an end face. In this respect, the circular hollow cylinder and the base can be two different components which are connected to one another or they can be one component. In the first-named alternative, both components can have identical chemical structures or can differ from one another with respect to their chemical composition as long as both components have a composition as previously described.

To facilitate the removal of the firing aid from the furnace and/or the introduction of the firing aid into the furnace, for example with the aid of tongs, and to facilitate the heat input into the firing aid, it is proposed in a further development of the idea of the invention that the firing aid has one or more openings at the jacket surface of the circular hollow cylinder. Alternatively to this or additionally to this, the margin of the circular hollow cylinder of the firing aid disposed opposite the base can also be configured in wavy form for the same purpose.

The present invention furthermore relates to a firing aid green body which
a) comprises at least 60% by weight mullite which comprises 74.0 to 78.0% by weight Al₂O₃, 22.0 to 26% by weight SiO₂ and a maximum of 0.5% by weight contaminants, with the sum of the Al₂O₃ content and of the SiO₂ content amounting to at least 99.5% by weight;
b) 1 to 20% by weight binder; and
c) 0.5 to 20% by weight plasticizer, with the sum of the components a), b) and c) amounting to 100% by weight. In this respect, a non-sintered molding is understood as the firing aid green body from which the firing aid in accordance with the invention is obtained.

The firing aid green body preferably comprises

a) 73 to 96% by weight and preferably 82 to 93% by weight mullite;
b) 3 to 12% by weight and preferably 3 to 6% by weight binder; and
c) 1 to 15 and preferably 4 to 12% by weight plasticizer,
with the sum of the components a), b) and c) amounting to 100% by weight.

The firing aid green body preferably comprises as the binder a mixture of water and glycerin, particularly preferably a mixture of 1 to 20% by weight, and very particularly preferably a mixture of 5 to 15% by weight of water and glycerin.

It is proposed in a further development of the idea of the invention that the firing aid green body comprises
a) 73 to 96% by weight mullite;
b) 3 to 12% by weight partially saponified polyvinyl acetate having a degree of saponification of 50 to 95 atomic percent, preferably of 70 to 90 atomic percent, and very particularly preferably of 75 to 90 atomic percent;
c) 1 to 15% by weight of a watery glycerin solution comprising 5 to 15% by weight,
   with the sum of the components a), b) and c) amounting to 100% by weight.

A further subject of the present invention is a method for manufacturing the previously described firing aid which includes the following steps:

a) providing a mixture of
at least 60% by weight mullite powder which comprises 74.0 to 78.0% by weight Al₂O₃, 22.0 to 26% by weight SiO₂ and a maximum of 0.5% contaminants, with the sum of the Al₂O₃ content and of the SiO₂ content amounting to at least 99.5% by weight;
1 to 20% by weight binder;
0 to 20% by weight plasticizer; and
remainder to 100% by weight of one or more additives;
   b) pressing the mixture provided in step a) to a green body; and
   c) sintering the green body.

The pressing in step b) is preferably carried out by (hot) isostatic pressing.

It is proposed in a further development of the idea of the invention to carry out the sintering in accordance with method step c) at a temperature between 1,000 and 2,500° C., preferably between 1,700 and 2,000° C., and particularly preferably between 1,700 and 1,800° C.

Due to the aforesaid properties of the firing aid in accordance with the invention, it is in particular suitable for use for supporting any kind of material to be fired in a furnace during the firing, in particular in an operation of the furnace at a temperature of more than 1,600° C., and even more than 1,800° C., as in particular for manufacturing a dental medical ceramic material to be fired such as a crown.

The present invention will be described in the following purely by way of example with reference to advantageous embodiments and to the enclosed drawings.

There are shown:

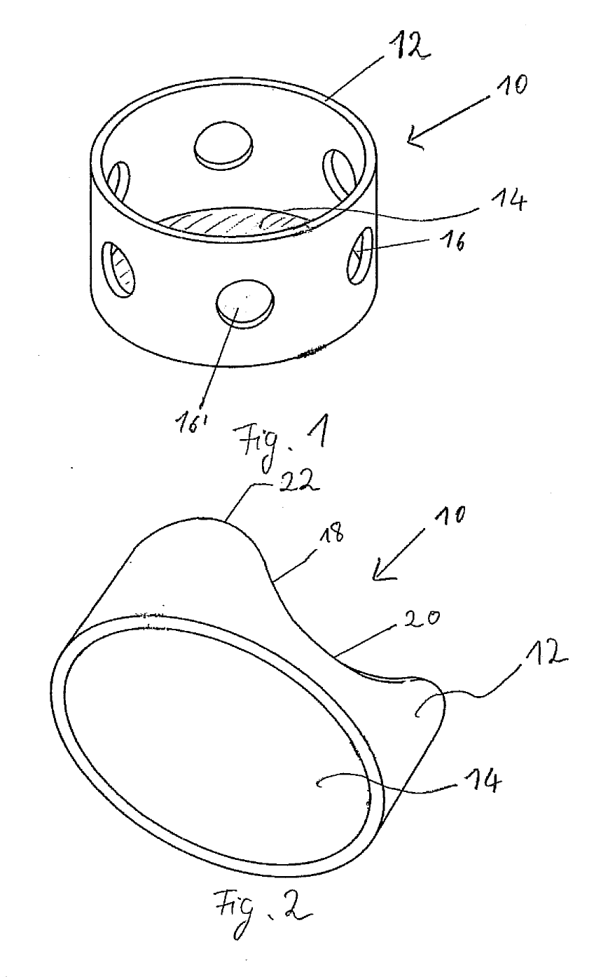

FIG. 1 a perspective view of a firing aid in accordance with a first embodiment; and

FIG. 2 a perspective view of a firing aid in accordance with a second embodiment.

The firing aid 10 presented in FIG. 1 comprises a circular hollow cylinder or ring 12 forming a wall and a base 14 which closes an end face of the circular hollow cylinder 12. A plurality of openings 16, 16′ are provided at the jacket surface of the circular hollow cylinder 12 in the form of circular cut-outs through which the firing aid 10 can easily be gripped by a tool such as by a pair of tongs and through which in addition a good and fast heat input into the firing aid 10 is ensured.

Unlike the firing aid 10 shown in FIG. 1, the margin 18 of the circular hollow cylinder or ring 12 of the firing element 10 shown in FIG. 2 forming the wall and disposed opposite the base 14 is configured in wavy form. In this respect, the wave troughs 20 permit a good and fast heat input into the firing aid 10, whereas the wave peaks 22 form support points for further firing aids above the firing aid 10.

### REFERENCE NUMERAL LIST

10 firing aid
12 circular hollow cylinder or ring
14 base
16, 16′ opening
18 margin
20 wave trough
22 wave peak

1. A firing aid, in particular for supporting material to be fired in a furnace during firing, the firing aid obtained by a method comprising:
a) providing a mixture of
at least 60% by weight mullite powder which comprises 74.0 to 78.0% by weight Al₂O₃, 22.0 to 26% by weight SiO₂ and a maximum of 0.5% contaminants, with the sum of the Al₂O₃ content and of the SiO₂ content amounting to at least 99.5% by weight;
1 to 20% by weight binder;
0 to 20% by weight plasticizer; and
remainder to 100% by weight of one or more additives;
b) pressing the mixture provided in step a) into a green body; and
c) sintering the green body.

2. A firing aid in accordance with claim 1,
characterized in that
the mullite used is 75.0 to 77.0% by weight Al₂O₃, 23.0 to 25.0% by weight SiO₂ and a maximum of 0.5% by weight contaminants, with the sum of the Al₂O₃ content and of the SiO₂ content amounting to at least 99.5% by weight.

3. A firing aid in accordance with claim 1,
characterized in that
the contaminants of the mullite used include a maximum of 0.3% by weight alkali oxides and alkaline-earth oxides.

4. A firing aid in accordance with claim 1,
characterized in that
the mullite used is 75.75 to 76.25% by weight Al₂O₃ and 23.25 to 23.75% by weight SiO₂.

5. A firing aid in accordance with claim 1,
characterized in that
it comprises at least 70% by weight of mullite.

6. A firing aid in accordance with claim 1,
characterized in that
the binder is an organic binder.

7. A firing aid in accordance with claim 19,
characterized in that
the binder is partially saponified polyvinyl acetate.

8. A firing aid in accordance with claim 1,
characterized in that
the mixture comprises 0.1 to 20% by weight of a plasticizer.

9. A firing aid in accordance with claim 1,
characterized in that
the mullite powder is two or more mullite powders each having a different particle size, with a first of the two or more mullite powders having an average particle size between 46 and 74 μm and a second of the two or more mullite powders having an average particle size between 10 and 45 μm.

10. A firing aid, in particular for supporting material to be fired in a furnace during firing, comprising:
74.0 to 78.0% by weight Al₂O₃; 22.0 to 26% by weight SiO₂; and a maximum of 0.5% by weight contaminants, with the sum of the Al₂O₃ and of the SiO₂ amounting to at least 99.5% by weight.

11. A firing aid in accordance with claim 1,
characterized in that
it has the form of a circular hollow cylinder (12) having a jacket surface and closed at an end face by a base (14).

12. A firing aid green body comprising:
a) at least 60% by weight mullite which comprises 74.0 to 78.0% by weight Al₂O₃, 22.0 to 26% by weight SiO₂ and a maximum of 0.5% contaminants, with the sum of the Al₂O₃ and of the SiO₂ amounting to at least 99.5% by weight;
b) 1 to 20% by weight binder; and
c) 0.5 to 20% by weight plasticizer,
with the sum of the components a), b) and c) amounting to 100% by weight.

13. A firing aid green body in accordance with claim 12, characterized in that
it includes
a) 73 to 96% by weight mullite;
b) 3 to 12% by weight binder; and
c) 1 to 15 by weight plasticizer,
with the sum of the components a), b) and c) amounting to 100% by weight.

14. A method for manufacturing a firing aid including the following steps:
a) providing a mixture of
at least 60% by weight mullite powder which comprises 74.0 to 78.0% by weight Al₂O₃, 22.0 to 26% by weight SiO₂ and a maximum of 0.5% contaminants, with the sum of the Al₂O₃ content and of the SiO₂ content amounting to at least 99.5% by weight;
1 to 20% by weight binder;
0 to 20% by weight plasticizer; and
remainder to 100% by weight of one or more additives;
b) pressing the mixture provided in step a) to a green body; and
c) sintering the green body.

15. A method in accordance with claim 14,
characterized in that
the sintering in accordance with step c) is carried out at a temperature between 1,000 and 2,500° C., preferably between 1,700 and 2,000° C.

16. Use of a firing aid in accordance with claim 10 for supporting material to be fired in a furnace during firing.

17. The use in accordance with claim 16 for manufacturing a dental medical ceramic material to be fired, such as a crown.

18. A firing aid in accordance with claim 1, characterized in that the mullite used is 76.0% by weight Al₂O₃ and 23.5% by weight SiO₂.

19. A firing aid in accordance with claim 6 characterized in that the binder is selected from a group consisting of: polyvinyl acetate, partially saponified polyvinyl acetate, polyvinyl alcohol and any desired mixtures of two or more of the aforesaid compounds.

20. A firing aid in accordance with claim 7 characterized in that the degree of saponification preferably amounts to 50 to 95 atomic percent.

21. A firing aid in accordance with claim 8 characterized in that the plasticizer is selected from a group consisting of polyethylene glycol, glycerin, water, a mixture of polyethylene glycol and water, or a mixture of glycerin and water.

22. A firing aid in accordance with claim 11 characterized in that the jacket surface of the circular hollow cylinder (12) has at least one opening (16, 16′).

23. A firing aid in accordance with claim 11 characterized in that the circular hollow cylinder (12) has a margin (18) disposed opposite the base (14), said margin being configured in a wavy form.

24. A firing aid, in particular for supporting material to be fired in a furnace during firing comprised essentially of:
sintered aluminum silicate; and
74.0 to 78.0% by weight Al₂O₃, 22.0 to 26% by weight SiO₂ and a maximum of 0.5% contaminants, with the sum of the Al₂O₃ content and of the SiO₂ content amounting to at least 99.5% by weight;
where the contaminants are free of silicon carbide, zirconium oxide, and titanium dioxide.
